(19) United States
(12) Patent Application Publication
(10) Pub. No.: US 2025/0024511 A1
(43) Pub. Date: Jan. 16, 2025

(54) MESSAGES FOR A FOUR-STEP RANDOM ACCESS CHANNEL PROCEDURE WITH BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/713,498

(22) PCT Filed: Jan. 28, 2022
(86) PCT No.: PCT/CN2022/074511

§ 371 Date: May 24, 2024

(51) Int. Cl. H04W 74/0833; H04B 7/06; H04B 17/318

(52) U.S. Cl. CPC H04W 74/0833; H04B 7/06968; H04B 17/328

(57) ABSTRACT

Various aspects of the present disclosure generally relate to wireless communication. In some aspects, a user equipment (UE) may transmit a message 1 (msg1) report message, of a four-step random access channel (RACH) procedure, identifying information associated with a plurality of synchronization signal blocks (SSBs), wherein the information includes a plurality of SSB indices associated with the plurality of SSBs. The UE may receive, based at least in part on transmitting the msg1 report message, a message 2 (msg2) update message, of the four-step RACH procedure, with an indication of a downlink beam associated with an SSB index of the plurality of SSB indices. The UE may transmit a response message, based at least in part on receiving the msg2 update message, indicating a confirmation of the SSB index indicated in the msg2 update message or indicating a reversion to a different SSB index.

### FIELD OF THE DISCLOSURE

Aspects of the present disclosure generally relate to wireless communication and to techniques and apparatuses for a four-step random access channel procedure with beam prediction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting a message 1 (msg1) report message, of a four-step random access channel (RACH) procedure, identifying information associated with a plurality of synchronization signal blocks (SSBs), wherein the information includes a plurality of SSB indices associated with the plurality of SSBs. The method may include receiving, based at least in part on transmitting the msg1 report message, a message 2 (msg2) update message, of the four-step RACH procedure, with an indication of a downlink beam associated with an SSB index of the plurality of SSB indices. The method may include transmitting a response message, based at least in part on receiving the msg2 update message, indicating a confirmation of the SSB index indicated in the msg2 update message or indicating a reversion to a different SSB index.

Some aspects described herein relate to a method of wireless communication performed by a UE. The method may include transmitting a message 3 (msg3) report message, of a four-step RACH procedure, identifying information associated with a plurality of SSBs, wherein the information includes at least one of a plurality of SSB indices associated with the plurality of SSBs or a plurality of reference signal received powers (RSRPs) corresponding to the plurality of SSB indices and the plurality of SSBs. The method may include receiving, based at least in part on transmitting the msg3 report message, an update message identifying a downlink beam associated with an SSB. The method may include transmitting a response message, based at least in part on receiving the update message, indicating a confirmation of an SSB index identified in the update message or indicating a reversion to a different SSB index.

Some aspects described herein relate to a method of wireless communication performed by a base station. The method may include receiving a msg1 report message, of a four-step RACH procedure, identifying information associated with a plurality of SSBs, wherein the information includes a plurality of SSB indices associated with the plurality of SSBs. The method may include transmitting, based at least in part on receiving the msg1 report message, a msg2 update message, of the four-step RACH procedure, with an indication of a downlink beam associated with an SSB index of the plurality of SSB indices. The method may include receiving a response message, based at least in part on transmitting the msg2 update message, indicating a confirmation of the SSB index indicated in the msg2 update message or indicating a reversion to a different SSB index.

Some aspects described herein relate to a method of wireless communication performed by a base station. The method may include receiving a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The method may include transmitting, based at least in part on receiving the msg3 report message, an update message identifying a downlink beam associated with an SSB. The method may include receiving a response message, based at least in part on transmitting the update message, indicating a confirmation of an SSB index identified in the update message or indicating a reversion to a different SSB index.

Some aspects described herein relate to a UE for wireless communication. The UE may include a memory and one or more processors coupled to the memory. The one or more processors may be configured to transmit a msg1 report message, of a four-step RACH procedure, identifying information associated with a plurality of SSBs, wherein the information includes a plurality of SSB indices associated with the plurality of SSBs. The one or more processors may be configured to receive, based at least in part on transmitting the msg1 report message, a msg2 update message, of the four-step RACH procedure, with an indication of a downlink beam associated with an SSB index of the plurality of SSB indices. The one or more processors may be configured to transmit a response message, based at least in part on receiving the msg2 update message, indicating a confirmation of the SSB index indicated in the msg2 update message or indicating a reversion to a different SSB index.

Some aspects described herein relate to a UE for wireless communication. The UE may include a memory and one or more processors coupled to the memory. The one or more processors may be configured to transmit a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The one or more processors may be configured to receive, based at least in part on transmitting the msg3 report message, an update message identifying a downlink beam associated with an SSB. The one or more processors may be configured to transmit a response message, based at least in part on receiving the update message, indicating a confirmation of an SSB index identified in the update message or indicating a reversion to a different SSB index.

Some aspects described herein relate to a base station for wireless communication. The base station may include a memory and one or more processors coupled to the memory. The one or more processors may be configured to receive a msg1 report message, of a four-step RACH procedure, identifying information associated with a plurality of SSBs, wherein the information includes a plurality of SSB indices associated with the plurality of SSBs. The one or more processors may be configured to transmit, based at least in part on receiving the msg1 report message, a msg2 update message, of the four-step RACH procedure, with an indication of a downlink beam associated with an SSB index of the plurality of SSB indices. The one or more processors may be configured to receive a response message, based at least in part on transmitting the msg2 update message, indicating a confirmation of the SSB index indicated in the msg2 update message or indicating a reversion to a different SSB index.

Some aspects described herein relate to a base station for wireless communication. The base station may include a memory and one or more processors coupled to the memory. The one or more processors may be configured to receive a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The one or more processors may be configured to transmit, based at least in part on receiving the msg3 report message, an update message identifying a downlink beam associated with an SSB. The one or more processors may be configured to receive a response message, based at least in part on transmitting the update message, indicating a confirmation of an SSB index identified in the update message or indicating a reversion to a different SSB index.

Some aspects described herein relate to a non-transitory computer-readable medium that stores a set of instructions for wireless communication by a UE. The set of instructions, when executed by one or more processors of the UE, may cause the UE to transmit a msg1 report message, of a four-step RACH procedure, identifying information associated with a plurality of SSBs, wherein the information includes a plurality of SSB indices associated with the plurality of SSBs. The set of instructions, when executed by one or more processors of the UE, may cause the UE to receive, based at least in part on transmitting the msg1 report message, a msg2 update message, of the four-step RACH procedure, with an indication of a downlink beam associated with an SSB index of the plurality of SSB indices. The set of instructions, when executed by one or more processors of the UE, may cause the UE to transmit a response message, based at least in part on receiving the msg2 update message, indicating a confirmation of the SSB index indicated in the msg2 update message or indicating a reversion to a different SSB index.

Some aspects described herein relate to a non-transitory computer-readable medium that stores a set of instructions for wireless communication. The set of instructions, when executed by one or more processors of a UE, may cause the one or more processors to transmit a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The set of instructions, when executed by one or more processors of the UE, may cause the one or more processors to receive, based at least in part on transmitting the msg3 report message, an update message identifying a downlink beam associated with an SSB. The set of instructions, when executed by one or more processors of the UE, may cause the one or more processors to transmit a response message, based at least in part on receiving the update message, indicating a confirmation of an SSB index identified in the update message or indicating a reversion to a different SSB index.

Some aspects described herein relate to a non-transitory computer-readable medium that stores a set of instructions for wireless communication by a base station. The set of instructions, when executed by one or more processors of the base station, may cause the base station to receive a msg1 report message, of a four-step RACH procedure, identifying information associated with a plurality of SSBs, wherein the information includes a plurality of SSB indices associated with the plurality of SSBs. The set of instructions, when executed by one or more processors of the base station, may cause the base station to transmit, based at least in part on receiving the msg1 report message, a msg2 update message, of the four-step RACH procedure, with an indication of a downlink beam associated with an SSB index of the plurality of SSB indices. The set of instructions, when executed by one or more processors of the base station, may cause the base station to receive a response message, based at least in part on transmitting the msg2 update message, indicating a confirmation of the SSB index indicated in the msg2 update message or indicating a reversion to a different SSB index.

Some aspects described herein relate to a non-transitory computer-readable medium that stores a set of instructions for wireless communication by a base station. The set of instructions, when executed by one or more processors of the base station, may cause the base station to receive a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The set of instructions, when executed by one or more processors of the base station, may cause the base station to transmit, based at least in part on receiving the msg3 report message, an update message identifying a downlink beam associated with an SSB. The set of instructions, when executed by one or more processors of the base station, may cause the base station to receive a response message, based at least in part on transmitting the update message, indicating a confirmation of an SSB index identified in the update message or indicating a reversion to a different SSB index.

Some aspects described herein relate to an apparatus for wireless communication. The apparatus may include means for transmitting a msg1 report message, of a four-step RACH procedure, identifying information associated with a plurality of SSBs, wherein the information includes a plurality of SSB indices associated with the plurality of SSBs. The apparatus may include means for receiving, based at least in part on transmitting the msg1 report message, a msg2 update message, of the four-step RACH procedure, with an indication of a downlink beam associated with an SSB index of the plurality of SSB indices. The apparatus may include means for transmitting a response message, based at least in part on receiving the msg2 update message, indicating a confirmation of the SSB index indicated in the msg2 update message or indicating a reversion to a different SSB index.

Some aspects described herein relate to an apparatus for wireless communication. The apparatus may include means for transmitting a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The apparatus may include means for receiving, based at least in part on transmitting the msg3 report message, an update message identifying a downlink beam associated with an SSB. The apparatus may include means for transmitting a response message, based at least in part on receiving the update message, indicating a confirmation of an SSB index identified in the update message or indicating a reversion to a different SSB index.

Some aspects described herein relate to an apparatus for wireless communication. The apparatus may include means for receiving a msg1 report message, of a four-step RACH procedure, identifying information associated with a plurality of SSBs, wherein the information includes a plurality of SSB indices associated with the plurality of SSBs. The apparatus may include means for transmitting, based at least in part on receiving the msg1 report message, a msg2 update message, of the four-step RACH procedure, with an indication of a downlink beam associated with an SSB index of the plurality of SSB indices. The apparatus may include means for receiving a response message, based at least in part on transmitting the msg2 update message, indicating a confirmation of the SSB index indicated in the msg2 update message or indicating a reversion to a different SSB index.

Some aspects described herein relate to an apparatus for wireless communication. The apparatus may include means for receiving a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The apparatus may include means for transmitting, based at least in part on receiving the msg3 report message, an update message identifying a downlink beam associated with an SSB. The apparatus may include means for receiving a response message, based at least in part on transmitting the update message, indicating a confirmation of an SSB index identified in the update message or indicating a reversion to a different SSB index.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of channel state information (CSI) reference signal (RS) (CSI-RS) beam management procedures, in accordance with the present disclosure.

FIG. 4 is a diagram illustrating an example of a four-step random access procedure, in accordance with the present disclosure.

FIGS. 5A and 5B are diagrams illustrating an example associated with a four-step random access procedure for beam prediction, in accordance with the present disclosure.

FIGS. 6-9 are diagrams illustrating example processes associated with a four-step random access procedure for beam prediction, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

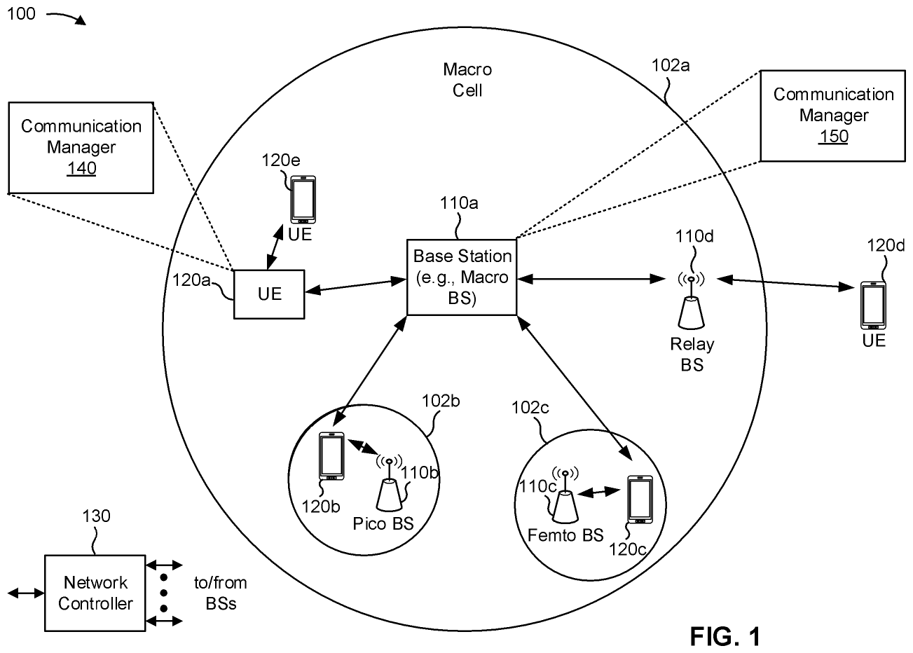

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. Abase station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a message 1 (msg1) report message, of a four-step random access channel (RACH) procedure, identifying information associated with a plurality of synchronization signal blocks (SSBs), wherein the information includes a plurality of SSB indices associated with the plurality of SSBs; receive, based at least in part on transmitting the msg1 report message, a message 2 (msg2) update message, of the four-step RACH procedure, with an indication of a downlink beam associated with an SSB index of the plurality of SSB indices; and transmit a response message, based at least in part on receiving the msg2 update message, indicating a confirmation of the SSB index indicated in the msg2 update message or indicating a reversion to a different SSB index. Additionally, or alternatively, the communication manager 140 may perform one or more other operations described herein.

In some aspects, as described in more detail elsewhere herein, the communication manager 140 may transmit a msg3 report message, of a four-step RACH procedure, identifying information associated with a plurality of SSBs, wherein the information includes at least one of a plurality of SSB indices associated with the plurality of SSBs or a plurality of reference signal received powers (RSRPs) corresponding to the plurality of SSB indices and the plurality of SSBs; receive, based at least in part on transmitting the msg3 report message, an update message identifying a downlink beam associated with an SSB; and transmit a response message, based at least in part on receiving the update message, indicating a confirmation of an SSB index identified in the update message or indicating a reversion to a different SSB index. Additionally, or alternatively, the communication manager 140 may perform one or more other operations described herein.

In some aspects, the base station 110 may include a communication manager 150. As described in more detail elsewhere herein, the communication manager 150 may receive a msg1 report message, of a four-step RACH procedure, identifying information associated with a plurality of SSBs, wherein the information includes a plurality of SSB indices associated with the plurality of SSBs; transmit, based at least in part on receiving the msg1 report message, a msg2 update message, of the four-step RACH procedure, with an indication of a downlink beam associated with an SSB index of the plurality of SSB indices; and receive a response message, based at least in part on transmitting the msg2 update message, indicating a confirmation of the SSB index indicated in the msg2 update message or indicating a reversion to a different SSB index. Additionally, or alternatively, the communication manager 150 may perform one or more other operations described herein.

In some aspects, as described in more detail elsewhere herein, the communication manager 150 may receive a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs; transmit, based at least in part on receiving the msg3 report message, an update message identifying a downlink beam associated with an SSB; and receive a response message, based at least in part on transmitting the update message, indicating a confirmation of an SSB index identified in the update message or indicating a reversion to a different SSB index. Additionally, or alternatively, the communication manager 150 may perform one or more other operations described herein.

As indicated above, FIG. 1 is provided as an example. Other examples may differ from what is described with regard to FIG. 1.

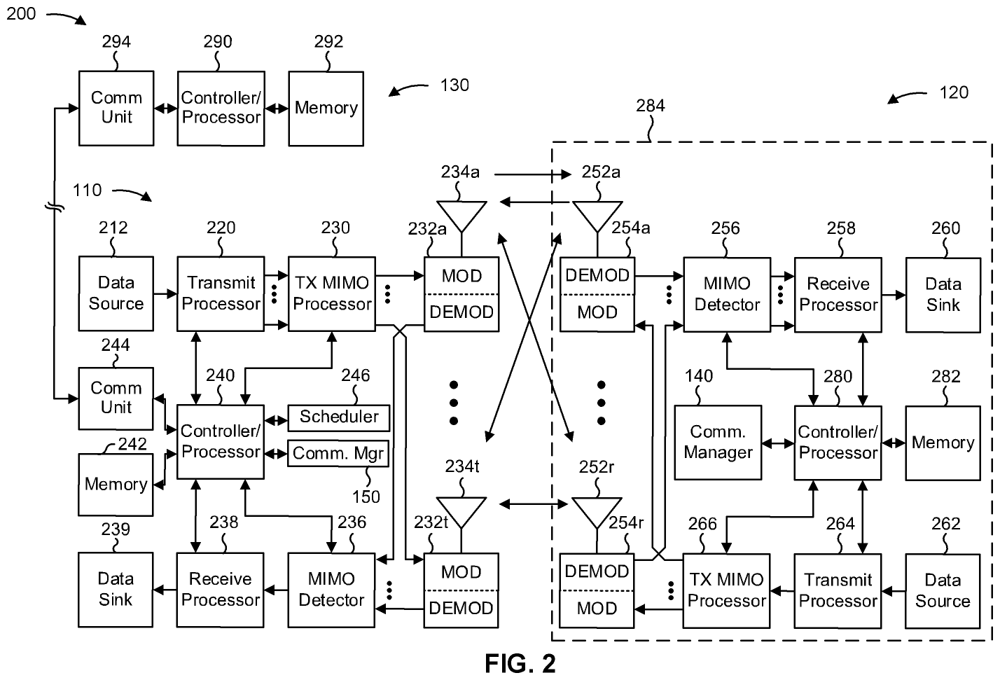

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

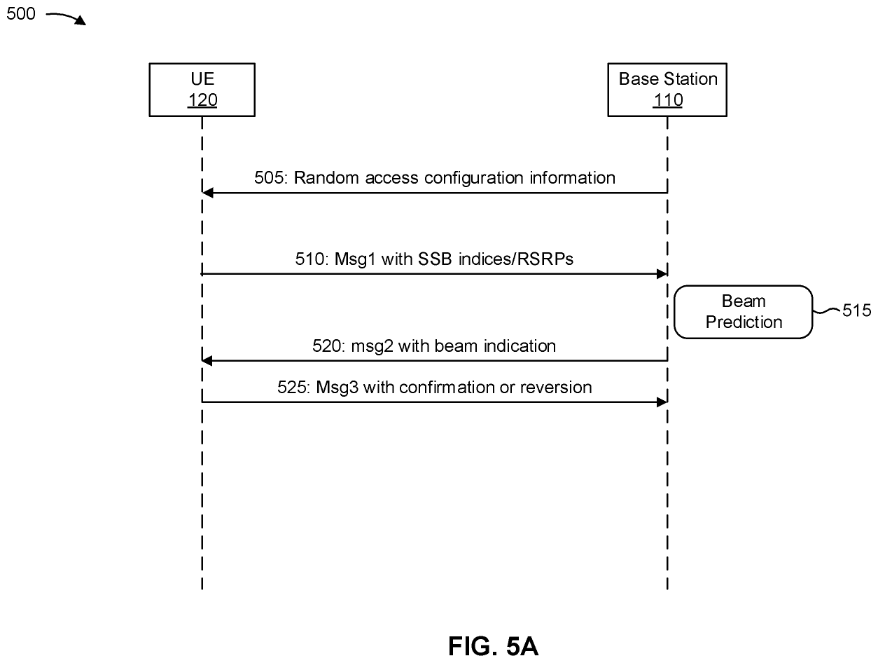

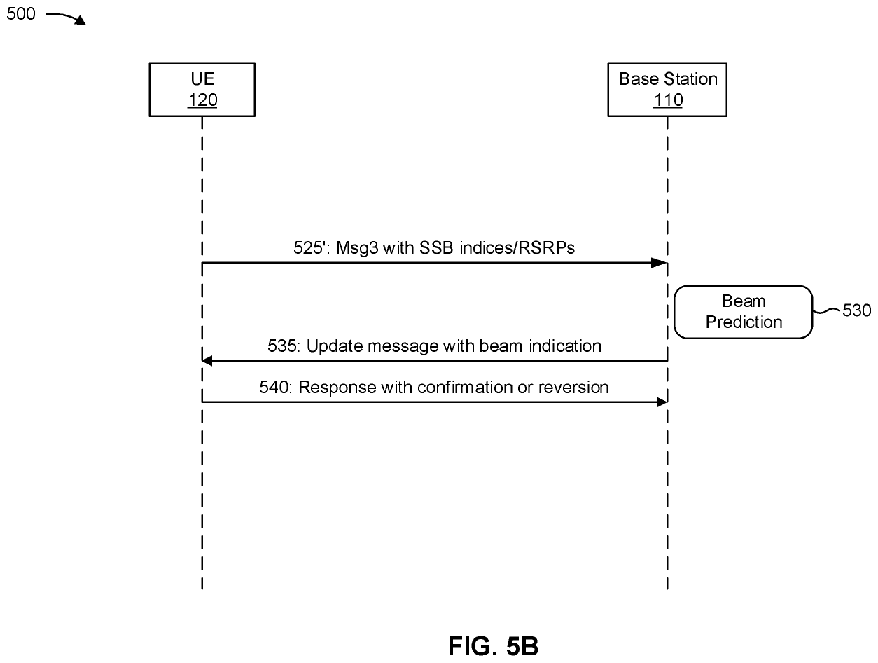

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-11).

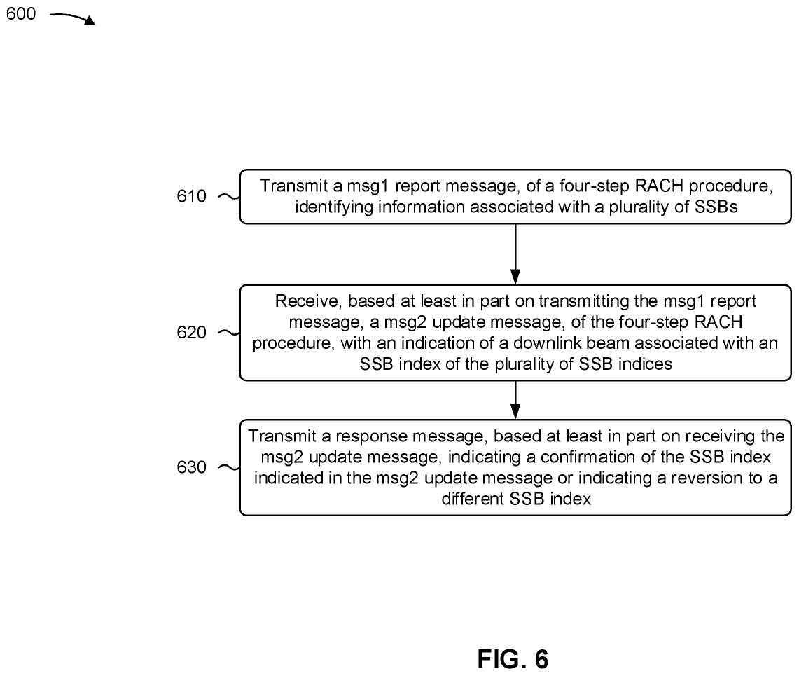

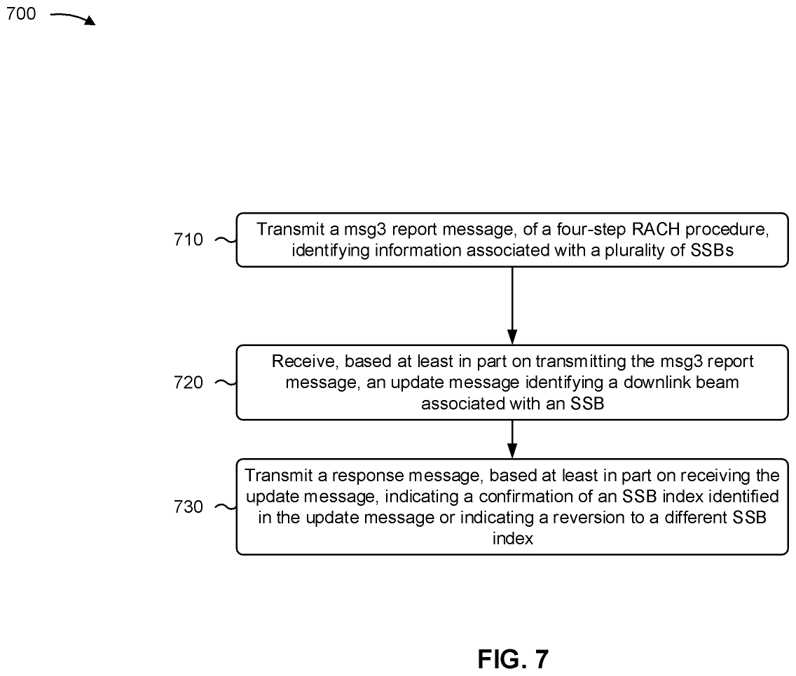

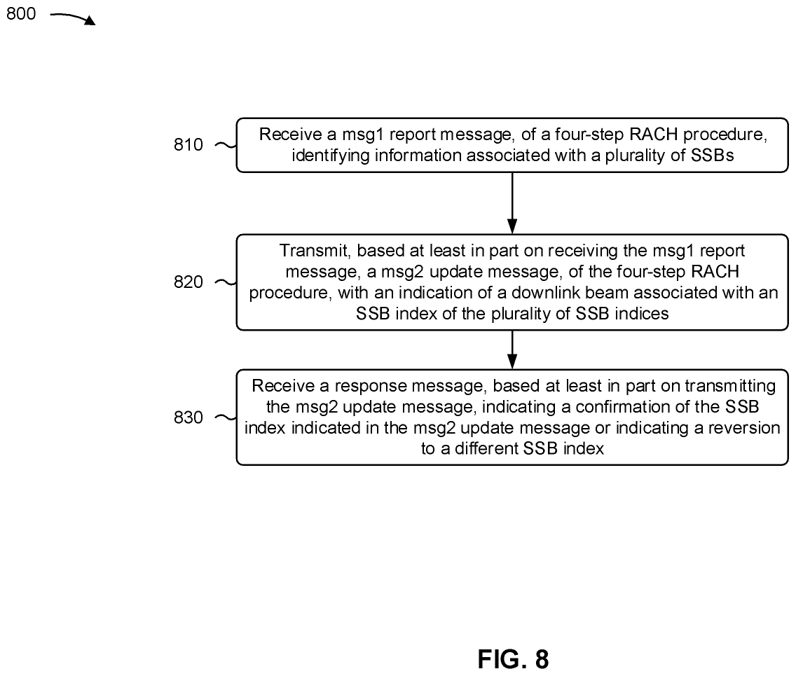

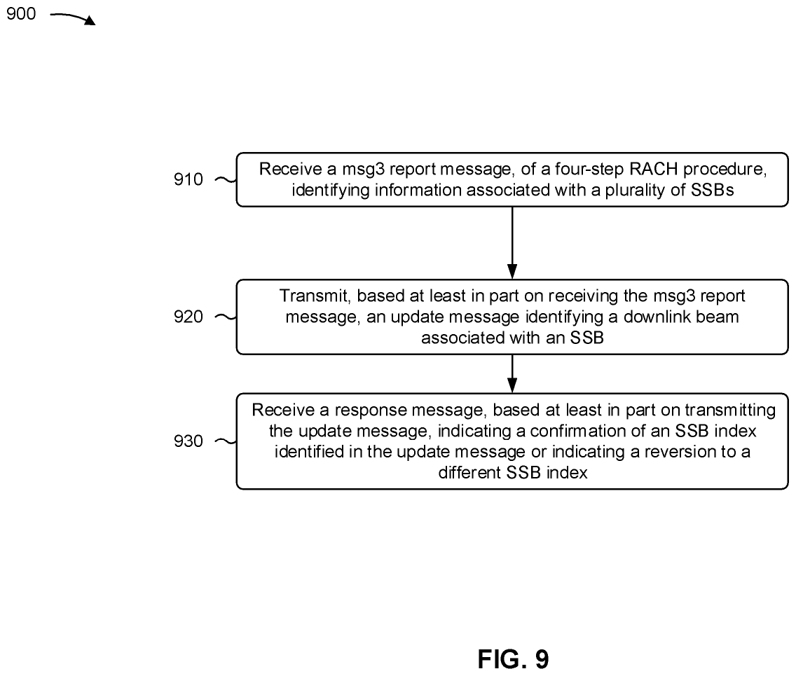

The controller/processor 240 of the base station 110, the controller/processor 280 of the UE 120, and/or any other component(s) of FIG. 2 may perform one or more techniques associated with a four-step RACH procedure for beam prediction, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for transmitting a msg1 report message, of a four-step RACH procedure, identifying information associated with a plurality of SSBs, wherein the information includes a plurality of SSB indices associated with the plurality of SSBs; means for receiving, based at least in part on transmitting the msg1 report message, a msg2 update message, of the four-step RACH procedure, with an indication of a downlink beam associated with an SSB index of the plurality of SSB indices; and/or means for transmitting a response message, based at least in part on receiving the msg2 update message, indicating a confirmation of the SSB index indicated in the msg2 update message or indicating a reversion to a different SSB index. Additionally, or alternatively, the UE 120 includes means for transmitting a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs; means for receiving, based at least in part on transmitting the msg3 report message, an update message identifying a downlink beam associated with an SSB; and/or means for transmitting a response message, based at least in part on receiving the update message, indicating a confirmation of an SSB index identified in the update message or indicating a reversion to a different SSB index. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for receiving a msg1 report message, of a four-step RACH procedure, identifying information associated with a plurality of SSBs, wherein the information includes a plurality of SSB indices associated with the plurality of SSBs; means for transmitting, based at least in part on receiving the msg1 report message, a msg2 update message, of the four-step RACH procedure, with an indication of a downlink beam associated with an SSB index of the plurality of SSB indices; and/or means for receiving a response message, based at least in part on transmitting the msg2 update message, indicating a confirmation of the SSB index indicated in the msg2 update message or indicating a reversion to a different SSB index. Additionally, or alternatively, the base station 110 includes means for receiving a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs; means for transmitting, based at least in part on receiving the msg3 report message, an update message identifying a downlink beam associated with an SSB; and/or means for receiving a response message, based at least in part on transmitting the update message, indicating a confirmation of an SSB index identified in the update message or indicating a reversion to a different SSB index. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

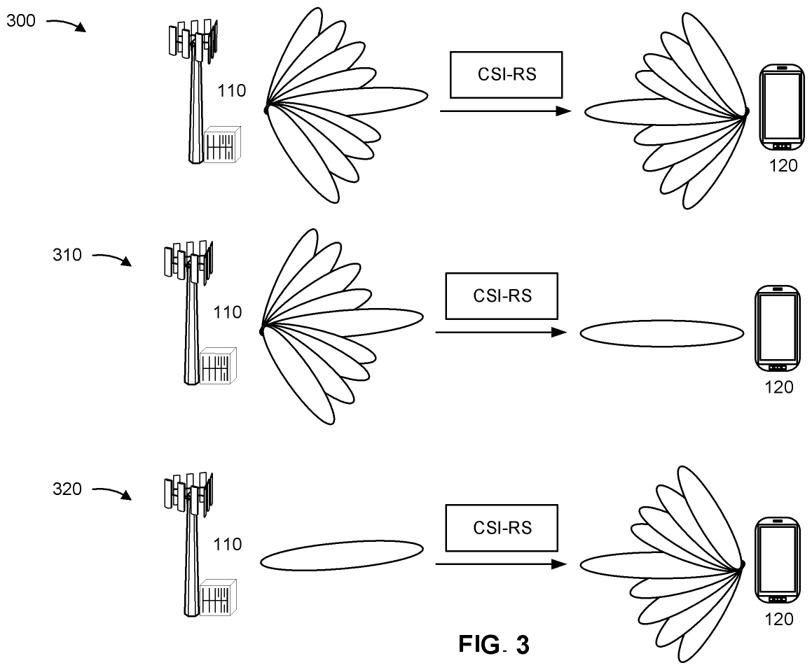

FIG. 3 is a diagram illustrating examples 300, 310, and 320 of channel state information (CSI) reference signal (RS) (CSI-RS) beam management procedures, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., a radio resource control (RRC) connected state).

As shown in FIG. 3, example 300 may include a base station 110 and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic CSI-RSs (P-CSI-RSs) (e.g., using RRC signaling), semi-persistent (SP) CSI-RSs (SP-CSI-RSs) (e.g., using media access control (MAC) control element (CE) (MAC-CE) signaling), and/or aperiodic (AP) CSI-RSs (AP-CSI-RSs) (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station 110 may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120.

As a result, the first beam management procedure may enable the UE 120 to measure a CSI-RS on different transmit beams using different receive beams to support selection of base station 110 transmit beam(s)/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use synchronization signal blocks (SSBs) for beam management in a similar manner as described above. For example, UE 120 and base station 110 may perform SSB beam sweeping (e.g., during initial access along with SSB and random access channel (RACH) association) to select a beam pair with a course granularity (e.g., by using wider, layer 1 (L1) beams) before performing CSI-RS beam sweeping (e.g., in a connected mode) to select a beam pair with a finer granularity (e.g., using hierarchical beam refinement, as described herein).

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a hierarchical beam refinement procedure (e.g., a P1, P2, or P3 procedure, as described herein), a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station 110 may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams). In some cases, beam failure recovery procedures may be used to recover a beam after a detected beam failure or radio link failure procedures may be used to identify a new beam after a detected beam or radio link failure.

In some cases, the UE 120 and the base station 110 may use beam prediction to reduce a quantity of beam measurements associated with selecting a beam (e.g., in one or more of the aforementioned beam management procedures). For example, when beam prediction is not used, the UE 120 and the base station 110 may communicate (e.g., by transmitting a CSI-RS and performing measurements and by reporting the measurements) on each beam across a beam sweep. However, when, for example, the base station 110 performs a beam prediction procedure, the base station 110 and the UE 120 may forgo transmission or measurement of one or more beams of the beam sweep. For example, for a set of consecutive beams (e.g., consecutive with regard to beam angle) that are configured for the base station 110, the base station 110 may forgo transmission of one or more beams within the set of consecutive beams. In this case, the base station 110 may completely forgo one or more beam transmissions or may selectively transmit one or more beams (e.g., sometimes forgo one or more beam transmissions) based at least in part on whether the UE 120 is performing initial access or not, based at least in part on how recently the one or more beams were transmitted, or based at least in part on a configured periodicity, among other examples. Additionally, or alternatively, the base station 110 may transmit all of the beams in the set of consecutive beams, but the UE 120 may forgo measurement and/or reporting of one or more beams within the set of consecutive beams. In these cases, the base station 110 and/or the UE 120 may interpolate (e.g., using artificial intelligence or another prediction technique) from measured beams to predict beam measurements (e.g., an RSRP) for one or more beams that have not been transmitted and/or measured. For example, UE 120 may predict a beam measurement of a beam, which the UE 120 has selected to forgo measuring, based at least in part on one or more other beam measurements and may report the predicted beam measurement to base station 110. Additionally, or alternatively, the UE 120 may forgo reporting a beam measurement for the beam, which the UE 120 has selected to forgo measuring, and the base station 110 may predict a beam measurement for the beam. In this case, the base station 110 may use the predicted beam measurement with actual beam measurements to configure communications, as described herein.

Similarly, the base station 110 and/or the UE 120 may forgo transmission and measurement of beams with a higher granularity. For example, rather than a first beam management procedure using wide beams and a second beam management procedure using narrow beams, the base station 110 may forgo transmission and/or the UE 120 may forgo measurement of the narrow beams. In this case, the base station 110 and/or the UE 120 may predict beam measurements for the narrow beams (e.g., that have not been transmitted and/or measured) based at least in part on beam measurements of the wide beams (e.g., that have been transmitted and measured) and/or based at least in part on past beam predictions or measurements. In these ways, the base station 110 and/or the UE 120 reduce a quantity of UE-side beam measurements and/or a UE-specific communication overhead, thereby improving UE performance and/or network performance.

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

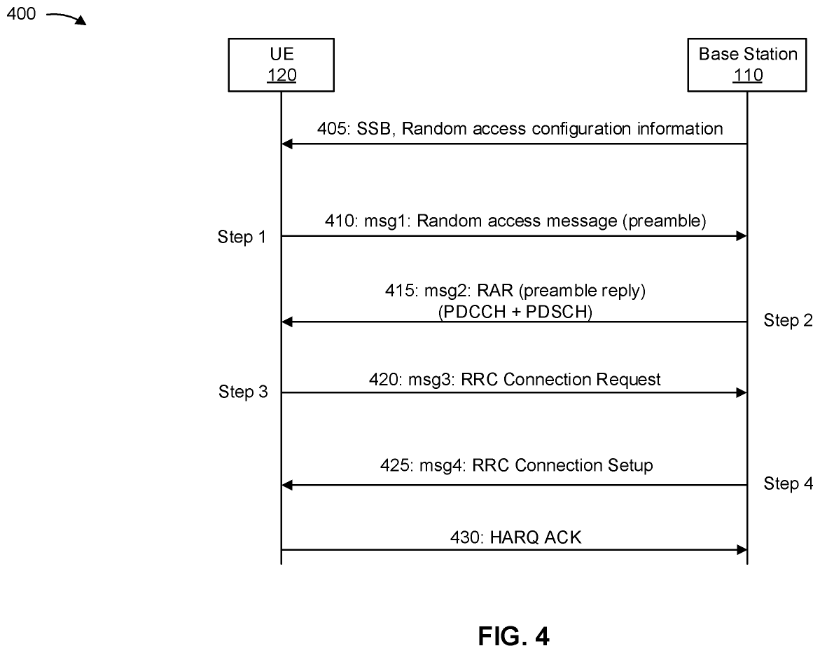

FIG. 4 is a diagram illustrating an example 400 of a four-step random access channel (RACH) procedure (which may also be termed a four-step random access procedure), in accordance with the present disclosure. As shown in FIG. 4, a base station 110 and a UE 120 may communicate with one another to perform the four-step RACH procedure.

As shown by reference number 405, the base station 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a physical random access channel (PRACH) preamble, or a RAM preamble). The message that includes the preamble may be referred to as a message 1, message type-1, msg1, MSG1, a first message, or an initial message in a four-step RACH procedure. The random access message may include a random access preamble identifier.

As shown by reference number 415, the base station 110 may transmit an RAR as a reply to the preamble. The message that includes the RAR may be referred to as message 2, message type-2, msg2, MSG2, or a second message in a four-step RACH procedure. In some aspects, the RAR may indicate the detected random access preamble identifier (e.g., received from the UE 120 in msg1). Additionally, or alternatively, the RAR may indicate a resource allocation to be used by the UE 120 to transmit message 3, which may also be referred to as message type-3, msg3, MSG3, or a third message in a four-step RACH procedure.

In some aspects, as part of the second step of the four-step RACH procedure, the base station 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also, as part of the second step of the four-step RACH procedure, the base station 110 may transmit the PDSCH communication for the RAR, as scheduled by the PDCCH communication. The RAR may be included in a medium access control (MAC) protocol data unit (PDU) of the PDSCH communication.

As shown by reference number 420, the UE 120 may transmit a radio resource control (RRC) connection request message. The RRC connection request message may be the aforementioned msg3 of the four-step RACH procedure. In some aspects, the RRC connection request may include a UE identifier, uplink control information (UCI), and/or a physical uplink shared channel (PUSCH) communication (e.g., an RRC connection request).

As shown by reference number 425, the base station 110 may transmit an RRC connection setup message. The RRC connection setup message may be referred to as message 4, message type-4, msg4, MSG4, or a fourth message of a four-step RACH procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgment (ACK).

As indicated above, FIG. 4 is provided as an example. Other examples may differ from what is described with regard to FIG. 4.

As described above, during a four-step RACH procedure, a UE may report a UE identifier, UCI, and/or a PUSCH transmission information regarding a measurement of a beam. For example, the UE may report a single SSB index for an associated RACH occasion (RO) and/or preamble. However, to perform beam prediction, a base station may use information regarding a plurality of SSBs or other reference signals. As a result, the UE may use a plurality of ROs and/or preambles to indicate a plurality of SSB indices, which may result in an excessive utilization of network resources.

Further, before RRC connection setup occurs, a base station may use a transmission configuration indicator (TCI) state update (e.g., configured via RRC signaling) and a TCJ state activation (e.g., using a MAC control element (CE) (MAC-CE)) in connection with DCI indicating an activated TCJ state codepoint. However, using a TCJ state update, TCJ state activation, and/or a TCJ state codepoint to indicate a beam may restrict base station flexibility to dynamically indicate a new downlink beam before an RRC connection setup occurs, which may result in a UE using a sub-optimal beam, thereby causing communication interruptions. In other words, the base station may not be able to dynamically indicate a new downlink beam, which may result in the UE using a previous downlink beam that is associated with worse parameters than the new downlink beam and which can result in dropped communications.

Some aspects described herein may provide a four-step RACH procedure to support beam prediction. For example, a UE may report, to a base station and using a four-step RACH procedure msg1, a plurality of SSB indices for a plurality of measured SSBs and/or a plurality of associated RSRPs for the plurality of measured SSBs. In this way, the UE enables reporting of beam information to the base station for beam prediction using a single RO, thereby reducing a utilization of communication resources relative to other four-step RACH procedure messages. The base station may select a beam (e.g., using beam prediction) for use by the UE and may transmit a four-step RACH procedure msg2 to indicate the selected beam to the UE. Based at least in part on receiving the msg2, the UE may transmit a response message to confirm the selected beam or indicate a reversion to a previously selected beam. In this way, the base station and the UE enable dynamic beam indication before RRC connection setup, thereby reducing a likelihood of communication interruptions associated with using a sub-optimal beam.

Additionally, or alternatively, the UE may report a plurality of SSB indices and/or a plurality of associated RSRPs in a PRACH procedure (e.g., via msg3 or another message after msg3). In this case, the base station may use the reported information for beam prediction and transmit a downlink message to select a beam associated with an SSB index of the plurality of SSB indices. Based at least in part on receiving the indication of the beam, the UE may transmit a message confirming the indicated beam and/or a message reverting to a previous beam. In this way, the UE and the base station achieve greater flexibility for PRACH procedures associated with msg3 of a four-step RACH procedure (or PRACH procedures associated with other messages occurring after msg3).

FIGS. 5A and 5B are diagrams illustrating an example 500 associated with a two-step RACH procedure for beam prediction, in accordance with the present disclosure. As shown in FIGS. 5A and 5B, example 500 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink.

As further shown in FIG. 5A, and by reference number 505, the UE 120 may receive RACH configuration information. For example, the UE 120 may receive, from the base station 110, a SIB type-1 (SIB1) including RACH configuration information for configuring RACH resources and/or reduced beam measurements, as described herein. For example, the UE 120 may receive information indicating that msg1 RACH resources are allocated to cover only a subset of configured SSB indices. In this case, the base station 110 may configure a first group of RACH resources for a first quantity of SSB indices for reporting in msg1 and may configure a group of RACH resources for indicating a second quantity of SSB indices in msg2 (e.g., the second quantity of SSB indices may be a subset of the first quantity of SSB indices based at least in part on a SIB1 indication). Alternatively, the base station 110 may configure RACH resources to cover all SSB indices. In this case, the first quantity of SSB indices and the second quantity of SSB indices may be the same quantity. In some aspects, RACH resources for reporting may cover all combinations of SSB indices that the UE 120 is configured to measure or a subset of combinations of SSB indices that the UE 120 is configured to measure. In some aspects, the SIB1 may include a bit indicator or other field to indicate whether the SIB1 is configuring RACH resources to cover all or a subset of SSB indices.

As further shown in FIG. 5A, and by reference number 510, the UE 120 may transmit a msg1 with a plurality of SSB indices and/or a plurality of identified RSRPs. For example, the UE 120 may transmit a msg1 to report a plurality of SSB indices associated with a plurality of measured SSBs (e.g., corresponding to a plurality of beams). Additionally, or alternatively, the UE 120 may transmit a msg1 to report a plurality of RSRPs associated with the plurality of measured SSBs. In some aspects, the UE 120 may transmit the msg1 based at least in part on an RO and/or a preamble partitioning. In some aspects, the UE 120 may determine at transmit beam for the msg1 based at least in part on an SSB index with a strongest measured RSRP. For example, UE 120 may use a beam associated with an SSB index for which a strongest RSRP is measured as the beam to use for uplink transmission of the msg1 to identify the beam (as well as one or more other measured beams).

In some aspects, the UE 120 may use an order of information in the msg1 to indicate a characteristic of the plurality of beams (e.g., an RSRP or another performed or predicted measurement) identified in the msg1. For example, the UE 120 may, for a single RO, transmit a plurality of preambles in an order corresponding to an order of RSRPs of SSBs identified in the plurality of preambles. In other words, the UE 120 may transmit a sequentially-first preamble identifying a first SSB with a first strongest RSRP, a sequentially-second preamble identifying a second SSB with a second strongest RSRP, and a sequentially-third preamble identifying a third SSB with a third strongest RSRP. Additionally, or alternatively, the UE 120 may transmit a plurality of preambles associated with a plurality of ROs, with each preamble and RO being associated with a plurality of ordered SSBs (e.g., ordered based at least in part on respective RSRPs). In this case, the UE 120 may transmit a first preamble associated with a first RO that identifies a first set of SSBs in a sequential order of RSRPs of the first set of SSBs, and may transmit a second preamble associated with a second RO that identifies a second set of SSBs in a sequential order of RSRPs of the second set of SSBs. Additionally, or alternatively, the UE 120 may transmit a plurality of preambles associated with a plurality of RO sets bundled for a plurality of SSB indices in an order of a strongest RSRP of SSBs of the plurality of RO sets. In other words, the UE 120 may transmit a first preamble associated with a first RO set and a first SSB with a first strongest RSRP, a second preamble associated with a second RO set and a second SSB with a second strongest RSRP, and a third preamble associated with a third RO set and a third SSB with a third strongest RSRP. In some aspects, an RO-to-SSB index association is based at least in part on an SSB with a strongest measured RSRP.

As further shown in FIG. 5A, and by reference number 515, the base station 110 may perform a beam prediction procedure. For example, as described herein, the base station 110 may select a beam for the UE 120 to use for communication based at least in part on a beam prediction procedure. In this case, the base station 110 may use reported SSB indices and/or RSRPs for one or more beams to predict RSRPs (or other parameters) for one or more other beams (e.g., for which measurements were not performed and/or reported). In this case, the base station 110 may select a beam based at least in part on a measurement or a predicted measurement.

As further shown in FIG. 5A, and by reference numbers 520 and 525, the UE 120 may receive a downlink message with a beam indication and may transmit a response message including a confirmation of a selected beam in the beam indication or a request for a reversion to a different (previous) beam. For example, the UE 120 may receive, from the base station 110, a msg2 (or another message occurring before RRC connection setup) that identifies a new downlink beam that the UE 120 is to use for communication with the base station 110.

In some aspects, the downlink message may include a field for receiving an SSB index that is not included in the plurality of msg1-reported SSB indices. For example, the UE 120 may report a first set of SSB indices in a msg1 and the base station 110 may transmit, in a msg2 PDSCH or in an RAR uplink (UL) grant MAC PDU, information identifying at least one second SSB index (e.g., that is not included in the first set of SSB indices). Additionally, or alternatively, the base station 110 may include, in a msg2 PDSCH or in an RAR UL grant MAC PDU, at least one SSB index that is included in the first set of SSB indices.

In some aspects, the UE 120 may determine a quasi-co-location (QCL) parameter based at least in part on an indicated SSB index. For example, when a msg2-indicated SSB index is the same as a msg1-reported SSB index with a strongest RSRP (e.g., among msg1-reported SSB indices), the UE 120 may maintain an existing downlink QCL assumption. Alternatively, the UE 120 may switch downlink QCL assumptions. For example, the UE 120 may switch from a first downlink QCL assumption (e.g., an existing downlink QCL assumption associated with the msg1-reported SSB index with the strongest RSRP) to a second downlink QCL assumption (e.g., associated with another SSB index that can be reported in, for example, a msg3 or another subsequent uplink message).

Additionally, or alternatively, when a msg2-indicated SSB index is different from a msg1-reported SSB index with a strongest RSRP (e.g., among msg1-reported SSB indices), the UE 120 may switch downlink QCL assumptions from a first downlink QCL assumption associated with the msg1-reported SSB index to a second downlink QCL assumption associated with the msg2-indicated SSB index. Alternatively, the UE 120 may continue using the first downlink QCL assumption and may use a msg3 or another uplink transmission to report that the UE 120 is to continue using the first downlink QCL assumption. Alternatively, the UE 120 may switch to a third downlink QCL assumption associated with another SSB index (e.g., another SSB index reported in msg1). In this case, the UE 120 may report usage of the other SSB index and the third downlink QCL assumption in a msg3 or another uplink transmission.

In some aspects, the UE 120 may interpret a received message (e.g., a msg2 PDSCH or a RAR UL grant MAC PDU) based at least in part on a format and/or a random access (RA) radio network temporary identifier (RNTI) (RA-RNTI). For example, the UE 120 may receive a message and interpret the message based at least in part on the message being an RAR UL grant MAC PDU with a particular format and an RA-RNTI associated with a RACH resource of msg1. Additionally, or alternatively, the UE 120 may receive a message and interpret the message based at least in part on a bit indicator indicating how to interpret one or more fields. For example, when the bit indicator is set to ‘0’, the UE 120 may determine that an indicated SSB index in the message is a msg1-reported SSB index with a strongest RSRP, but if the bit indicator is set to ‘1’, the UE 120 may determine that the indicated SSB index in the message is different from the msg1-reported SSB index with the strongest RSRP.

In some aspects, the UE 120 may transmit an uplink message to confirm an indicated beam. For example, the UE 120 may transmit a msg3 (or another message occurring before RRC connection setup) to the base station 110 to indicate that the UE 120 is to use the downlink beam indicated in, for example, a msg2 for communication with the base station 110. In this case, the UE 120 may include, in the msg3, information identifying an SSB index or a measured RSRP of the beam that the UE 120 is confirming.

In some aspects, the UE 120 may transmit an uplink message to revert to a previous beam rather than to confirm an indicated beam. For example, the UE 120 may transmit a msg3 (or another message occurring before RRC connection setup) to the base station 110 to indicate that the UE 120 is not to use the downlink beam indicated in, for example, a msg2 for communication with the base station 110. In this case, the UE 120 may include, in a msg3, information identifying an SSB index (e.g., at least one SSB index that is the same or different from the SSB index indicated in msg2) or a measured RSRP of the beam (e.g., of the at least one SSB index) to which the UE 120 is to revert. In some aspects, the UE 120 may use a downlink QCL assumption of the SSB index reported in msg3 for downlink messages after the msg3. In some aspects, the UE may use a corresponding uplink transmit beam (e.g., an uplink transmit beam corresponding to the downlink QCL assumption of the SSB index reported in msg3) for transmitting msg3 and/or other uplink messages after msg3.

In some aspects, the UE 120 may use another type of downlink or uplink message for communication with the base station 110 after msg2 (and/or after msg3). For example, the base station 110 may transmit an SSB index update message using a different downlink message than msg2 (e.g., after msg2). Additionally, or alternatively, the UE 120 may report at least one SSB index different from a base-station-indicated SSB index in another uplink message different than msg3 (e.g., after msg3). In this case, if the UE 120 reports a different SSB index, the UE 120 may use a downlink QCL assumption for subsequent downlink messages based at least in part on the SSB index reported in msg3. In contrast, the UE 120 may use an uplink transmit beam based at least in part on the SSB index reported in the other uplink message. In some aspects, the UE 120 may be constrained with regard to which SSB indices the UE 120 is to select for reverting to a previous beam. For example, the UE 120 may be constrained to revert to an SSB index reported in msg1 with a strongest RSRP. In this way, the UE 120 may avoid excess blind detection and/or digital receive beamforming issues for the base station 110.

As further shown in FIG. 5B, and by reference number 525′, the UE 120 may use an uplink message for transmission of a plurality of SSB indices and/or a plurality of corresponding RSRP values in connection with PRACH procedures. For example, the UE 120 may convey, in msg3 or another uplink message (e.g., a PUSCH or physical uplink control channel (PUCCH) message) after msg2 (or msgB in two-step RACH procedures), information identifying a plurality of SSB indices and RSRP values.

In this case, as shown by reference numbers 530 and 535, the base station 110 may perform a beam prediction using the plurality of SSB indices and corresponding RSRP values reported in msg3, and may transmit an update message with a beam indication. For example, the UE 120 may receive a downlink message (e.g., msg4 or another downlink message before RRC connection setup) with an SSB index corresponding to a beam that the UE 120 is to use for communication. In some aspects, the indicated SSB index of the downlink message and/or an SSB index reported by the UE 120 (e.g., in msg3 or a subsequent uplink message or reversion message) is based at least in part on a CSI report configuration. For example, the UE 120 may be configured (e.g., by the base station 110 using a SIB1 or other system information (SI) message) with a cell-common CSI report configuration (CSI-ReportConfig) with a report quantity (reportQuantity) parameter set to an SSB index RSRP (ssb-index-RSRP) value. In this case, the UE 120 may base reported SSB indices at least in part on the CSI report configuration. In some aspects, the UE 120 may be configured to request transmission of the CSI-report based at least in part on using a set of RACH resources (e.g., a RO or preamble) allocated for requesting to send the CSI report or by interpreting a configuration for a request from a content of msg3 or another uplink message before RRC setup (e.g., or msgA in a two-step RACH procedure). Similarly, the base station 110 may transmit an indication in msg2 or another downlink message before RRC connection setup to trigger the UE 120 to perform a CSI report. In this case, the UE 120 may transmit the CSI report using a PUCCH or by multiplexing the CSI report onto a PUSCH based at least in part on a configuration associated with the CSI report configuration.

As further shown in FIG. 5B, and by reference number 540, the UE 120 may transmit a response message with a confirmation of an indicated SSB index and associated beam or a reversion to a previous SSB index and associated beam. For example, the UE 120 may transmit, in an uplink message, information confirming the indicated SSB index and associated beam or reverting to a different SSB index associated with a different beam. As described above, when reverting to a different SSB index, the UE 120 may report at least one SSB index that is different from the SSB index indicated by the base station 110 and may report at least one measured RSRP associated with the at least one SSB index. In some aspects, as described above, the UE 120 may determine a QCL assumption when reporting a reversion to a different SSB index. For example, the UE 120 may use the reported at least one SSB index as a basis for a downlink QCL assumption for subsequent downlink messages. Additionally, or alternatively, the UE 120 may use a corresponding uplink beam for subsequent uplink messages based at least in part on the downlink QCL assumption. In some aspects, the UE 120 may be constrained to reverting to the SSB index reported in, for example, msg1, thereby avoiding excess blind detection and/or digital receive beamforming issues for the base station 110.

As indicated above, FIGS. 5A and 5B are provided as an example. Other examples may differ from what is described with respect to FIGS. 5A and 5B.

FIG. 6 is a diagram illustrating an example process 600 performed, for example, by a UE, in accordance with the present disclosure. Example process 600 is an example where the UE (e.g., UE 120) performs operations associated with a four-step RACH procedure for beam prediction.

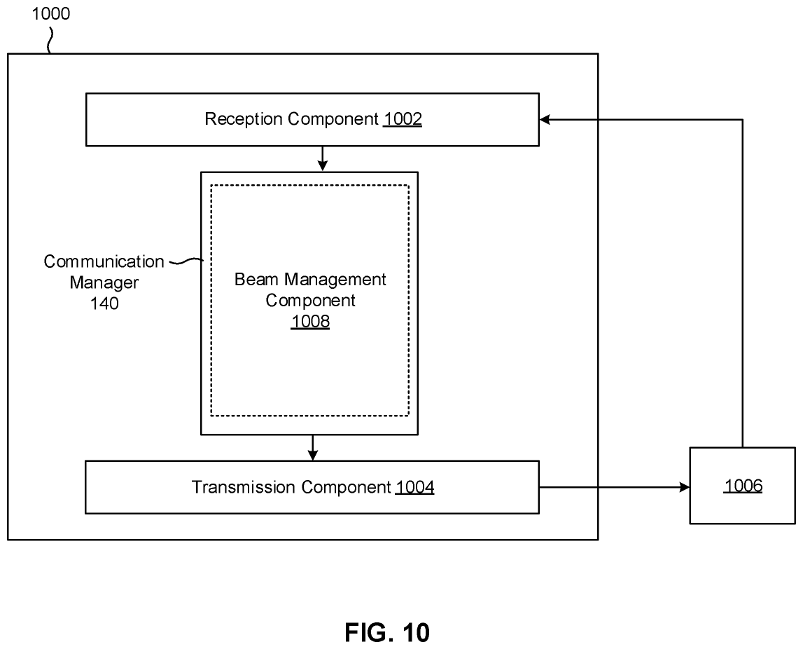

As shown in FIG. 6, in some aspects, process 600 may include transmitting a msg1 report message, of a four-step RACH procedure, identifying information associated with a plurality of SSBs (block 610). For example, the UE (e.g., using communication manager 140 and/or transmission component 1004, depicted in FIG. 10) may transmit a msg1 report message, of a four-step RACH procedure, identifying information associated with a plurality of SSBs, wherein the information includes a plurality of SSB indices associated with the plurality of SSBs, as described above.

As further shown in FIG. 6, in some aspects, process 600 may include receiving, based at least in part on transmitting the msg1 report message, a msg2 update message, of the four-step RACH procedure, with an indication of a downlink beam associated with an SSB index of the plurality of SSB indices (block 620). For example, the UE (e.g., using communication manager 140 and/or reception component 1002, depicted in FIG. 10) may receive, based at least in part on transmitting the msg1 report message, a msg2 update message, of the four-step RACH procedure, with an indication of a downlink beam associated with an SSB index of the plurality of SSB indices, as described above.

As further shown in FIG. 6, in some aspects, process 600 may include transmitting a response message, based at least in part on receiving the msg2 update message, indicating a confirmation of the SSB index indicated in the msg2 update message or indicating a reversion to a different SSB index (block 630). For example, the UE (e.g., using communication manager 140 and/or transmission component 1004, depicted in FIG. 10) may transmit a response message, based at least in part on receiving the msg2 update message, indicating a confirmation of the SSB index indicated in the msg2 update message or indicating a reversion to a different SSB index, as described above.

Process 600 may include additional aspects, such as any single aspect or any combination of aspects described below and/or in connection with one or more other processes described elsewhere herein.

In a first aspect, the response message is a msg3 of the four-step RACH procedure or another type of uplink message occurring before radio resource control setup associated with the four-step RACH procedure.

In a second aspect, alone or in combination with the first aspect, the msg1 report message is an enhanced msg1 including one or more fields for reporting the plurality of SSB indices.

In a third aspect, alone or in combination with one or more of the first and second aspects, the msg1 report message uses a RACH occasion or a RACH preamble partitioning to include one or more fields for reporting the plurality of SSB indices.

In a fourth aspect, alone or in combination with one or more of the first through third aspects, the msg1 report message includes a plurality of RACH preambles within a single RACH occasion conveying information identifying the plurality of SSB indices.

In a fifth aspect, alone or in combination with one or more of the first through fourth aspects, an order of the plurality of SSB indices within the msg1 report corresponds to an order of measured reference signal received powers (RSRPs) of the plurality of SSBs identified by the plurality of SSB indices.

In a sixth aspect, alone or in combination with one or more of the first through fifth aspects, a RACH occasion to SSB index association is based at least in part on a strongest measured RSRP of a plurality of measured RSRPs of the plurality of SSBs identified by the plurality of SSB indices.

In a seventh aspect, alone or in combination with one or more of the first through sixth aspects, the msg1 report message includes a RACH preamble associated with a RACH occasion that identifies two or more of the plurality of SSB indices.

In an eighth aspect, alone or in combination with one or more of the first through seventh aspects, the msg1 report message includes a plurality of RACH occasion sets associated with groups of SSB indices.

In a ninth aspect, alone or in combination with one or more of the first through eighth aspects, the UE is configured to determine a transmit beam based at least in part on an SSB index, of the plurality of SSB indices, with a strongest RSRP.

In a tenth aspect, alone or in combination with one or more of the first through ninth aspects, the msg2 update message includes a field for an SSB index included in the plurality of SSB indices of the msg1 report message or an SSB index not included in the plurality of SSB indices of the msg1 report message.

In an eleventh aspect, alone or in combination with one or more of the first through tenth aspects, a downlink QCL parameter is based at least in part on at least one of a value of the SSB index of the field of the msg2 update message, or whether the SSB index is included in the plurality of SSB indices of the msg1 report message or not included in the plurality of SSB indices of the msg1 report message.

In a twelfth aspect, alone or in combination with one or more of the first through eleventh aspects, a downlink quasi-co-location parameter is based at least in part on a random access response uplink grant medium access control protocol data unit format.

In a thirteenth aspect, alone or in combination with one or more of the first through twelfth aspects, a downlink quasi-co-location parameter is based at least in part on a grant format and a random access radio network temporary identifier associated with the msg1 report message.

In a fourteenth aspect, alone or in combination with one or more of the first through thirteenth aspects, the response message includes at least one of a first SSB index that is different from a second SSB index included in the msg2 update message, or an RSRP value for the first SSB index.

In a fifteenth aspect, alone or in combination with one or more of the first through fourteenth aspects, the UE is configured to use a downlink or uplink quasi-co-location parameter associated with an SSB index included in the response message.

In a sixteenth aspect, alone or in combination with one or more of the first through fifteenth aspects, the response message is constrained to include an SSB index, that is different from another SSB index of the msg2 update message, with a strongest RSRP.

In a seventeenth aspect, alone or in combination with one or more of the first through sixteenth aspects, process 600 includes receiving a system information block including RACH configuration information, wherein the RACH configuration information identifies at least one of msg1 RACH resources for a subset of SSB indices of a set of configured SSB indices, a grouping of RACH resources, a maximum quantity of SSB indices for the msg1 report message, a maximum quantity of SSB indices for the msg2 update message, an association between first SSB indices in the msg1 report message and second SSB indices in the msg2 update message, msg1 RACH resources for the set of configured SSB indices, or a configuration of one or more combinations of SSB indices associated with the msg1 RACH resources.

In an eighteenth aspect, alone or in combination with one or more of the first through seventeenth aspects, process 600 includes transmitting an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with a four-step random access channel procedure for beam prediction.

As shown in FIG. 7, in some aspects, process 700 may include transmitting a msg3 report message, of a four-step RACH procedure, identifying information associated with a plurality of SSBs (block 710). For example, the UE (e.g., using communication manager 140 and/or transmission component 1004, depicted in FIG. 10) may transmit a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs, as described above.

As further shown in FIG. 7, in some aspects, process 700 may include receiving, based at least in part on transmitting the msg3 report message, an update message identifying a downlink beam associated with an SSB (block 720). For example, the UE (e.g., using communication manager 140 and/or reception component 1002, depicted in FIG. 10) may receive, based at least in part on transmitting the msg3 report message, an update message identifying a downlink beam associated with an SSB, as described above.

As further shown in FIG. 7, in some aspects, process 700 may include transmitting a response message, based at least in part on receiving the update message, indicating a confirmation of an SSB index identified in the update message or indicating a reversion to a different SSB index (block 730). For example, the UE (e.g., using communication manager 140 and/or transmission component 1004, depicted in FIG. 10) may transmit a response message, based at least in part on receiving the update message, indicating a confirmation of an SSB index identified in the update message or indicating a reversion to a different SSB index, as described above.

Process 700 may include additional aspects, such as any single aspect or any combination of aspects described below and/or in connection with one or more other processes described elsewhere herein.

In a first aspect, the response message is an uplink message occurring before radio resource control setup associated with the four-step RACH procedure.

In a second aspect, alone or in combination with the first aspect, the update message is a downlink message occurring before radio resource control setup associated with the four-step RACH procedure.

In a third aspect, alone or in combination with one or more of the first and second aspects, the response message includes at least one of a first SSB index that is different from a second SSB index included in the update message, or an RSRP value for the first SSB index.

In a fourth aspect, alone or in combination with one or more of the first through third aspects, the UE is configured to use a downlink or uplink quasi-co-location parameter associated with an SSB index included in the response message.

In a fifth aspect, alone or in combination with one or more of the first through fourth aspects, the response message is constrained to include an SSB index, that is different from another SSB index of the update message, with a strongest RSRP of the plurality of RSRPs.

In a sixth aspect, alone or in combination with one or more of the first through fifth aspects, the plurality of SSB indices or the plurality of RSRPs is based at least in part on a CSI report configuration with a report quantity indicated via a system information message.

In a seventh aspect, alone or in combination with one or more of the first through sixth aspects, the UE is configured to transmit a request for a CSI report associated with the CSI report configuration based at least in part on a field of a RACH resource or an uplink transmission request.

In an eighth aspect, alone or in combination with one or more of the first through seventh aspects, the UE is configured to receive an indication in a msg2 of the four-step RACH procedure or another message before radio resource control setup associated with triggering the CSI report.

In a ninth aspect, alone or in combination with one or more of the first through eighth aspects, the UE is configured to transmit the CSI report via a physical uplink control channel or multiplexed on a physical uplink shared channel.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with a four-step random access channel procedure for beam prediction.

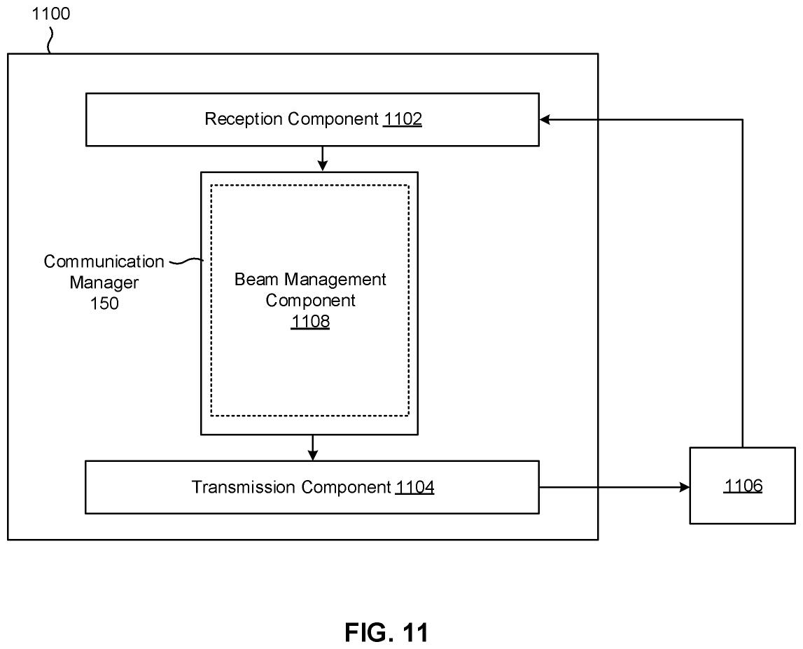

As shown in FIG. 8, in some aspects, process 800 may include receiving a msg1 report message, of a four-step RACH procedure, identifying information associated with a plurality of SSBs (block 810). For example, the base station (e.g., using communication manager 150 and/or reception component 1102, depicted in FIG. 11) may receive a msg1 report message, of a four-step RACH procedure, identifying information associated with a plurality of SSBs, wherein the information includes a plurality of SSB indices associated with the plurality of SSBs, as described above.

As further shown in FIG. 8, in some aspects, process 800 may include transmitting, based at least in part on receiving the msg1 report message, a msg2 update message, of the four-step RACH procedure, with an indication of a downlink beam associated with an SSB index of the plurality of SSB indices (block 820). For example, the base station (e.g., using communication manager 150 and/or transmission component 1104, depicted in FIG. 11) may transmit, based at least in part on receiving the msg1 report message, a msg2 update message, of the four-step RACH procedure, with an indication of a downlink beam associated with an SSB index of the plurality of SSB indices, as described above.

As further shown in FIG. 8, in some aspects, process 800 may include receiving a response message, based at least in part on transmitting the msg2 update message, indicating a confirmation of the SSB index indicated in the msg2 update message or indicating a reversion to a different SSB index (block 830). For example, the base station (e.g., using communication manager 150 and/or reception component 1102, depicted in FIG. 11) may receive a response message, based at least in part on transmitting the msg2 update message, indicating a confirmation of the SSB index indicated in the msg2 update message or indicating a reversion to a different SSB index, as described above.

Process 800 may include additional aspects, such as any single aspect or any combination of aspects described below and/or in connection with one or more other processes described elsewhere herein.

In a first aspect, the response message is a msg3 of the four-step RACH procedure or another type of uplink message occurring before radio resource control setup associated with the four-step RACH procedure.

In a second aspect, alone or in combination with the first aspect, the msg1 report message is an enhanced msg1 including one or more fields for reporting the plurality of SSB indices.

In a third aspect, alone or in combination with one or more of the first and second aspects, the msg1 report message uses a RACH occasion or a RACH preamble partitioning to include one or more fields for reporting the plurality of SSB indices.

In a fourth aspect, alone or in combination with one or more of the first through third aspects, the msg1 report message includes a plurality of RACH preambles within a single RACH occasion conveying information identifying the plurality of SSB indices.

In a fifth aspect, alone or in combination with one or more of the first through fourth aspects, an order of the plurality of SSB indices within the msg1 report corresponds to an order of measured RSRPs of the plurality of SSBs identified by the plurality of SSB indices.

In a sixth aspect, alone or in combination with one or more of the first through fifth aspects, a RACH occasion to SSB index association is based at least in part on a strongest measured RSRP of a plurality of measured RSRPs of the plurality of SSBs identified by the plurality of SSB indices.

In a seventh aspect, alone or in combination with one or more of the first through sixth aspects, the msg1 report message includes a RACH preamble associated with a RACH occasion that identifies two or more of the plurality of SSB indices.

In an eighth aspect, alone or in combination with one or more of the first through seventh aspects, the msg1 report message includes a plurality of RACH occasion sets associated with groups of SSB indices.

In a ninth aspect, alone or in combination with one or more of the first through eighth aspects, a transmit beam is based at least in part on an SSB index, of the plurality of SSB indices, with a strongest RSRP.

In a tenth aspect, alone or in combination with one or more of the first through ninth aspects, the msg2 update message includes a field for an SSB index included in the plurality of SSB indices of the msg1 report message or an SSB index not included in the plurality of SSB indices of the msg1 report message.

In an eleventh aspect, alone or in combination with one or more of the first through tenth aspects, a downlink QCL parameter is based at least in part on at least one of a value of the SSB index of the field of the msg2 update message, or whether the SSB index is included in the plurality of SSB indices of the msg1 report message or not included in the plurality of SSB indices of the msg1 report message.

In a twelfth aspect, alone or in combination with one or more of the first through eleventh aspects, a downlink quasi-co-location parameter is based at least in part on a random access response uplink grant medium access control protocol data unit format.

In a thirteenth aspect, alone or in combination with one or more of the first through twelfth aspects, a downlink quasi-co-location parameter is based at least in part on a grant format and a random access radio network temporary identifier associated with the msg1 report message.

In a fourteenth aspect, alone or in combination with one or more of the first through thirteenth aspects, the response message includes at least one of a first SSB index that is different from a second SSB index included in the msg2 update message, or a RSRP value for the first SSB index.

In a fifteenth aspect, alone or in combination with one or more of the first through fourteenth aspects, a downlink or uplink quasi-co-location parameter is based at least in part on an SSB index included in the response message.

In a sixteenth aspect, alone or in combination with one or more of the first through fifteenth aspects, the response message is constrained to include an SSB index, that is different from another SSB index of the msg2 update message, with a strongest RSRP.

In a seventeenth aspect, alone or in combination with one or more of the first through sixteenth aspects, process 800 includes transmitting a system information block including RACH configuration information, wherein the RACH configuration information identifies at least one of msg1 RACH resources for a subset of SSB indices of a set of configured SSB indices, a grouping of RACH resources, a maximum quantity of SSB indices for the msg1 report message, a maximum quantity of SSB indices for the msg2 update message, an association between first SSB indices in the msg1 report message and second SSB indices in the msg2 update message, msg1 RACH resources for the set of configured SSB indices, or a configuration of one or more combinations of SSB indices associated with the msg1 RACH resources.

In an eighteenth aspect, alone or in combination with one or more of the first through seventeenth aspects, process 800 includes receiving an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with messages for a four-step random access channel procedure with beam prediction.

As shown in FIG. 9, in some aspects, process 900 may include receiving a msg3 report message, of a four-step RACH procedure, identifying information associated with a plurality of SSBs (block 910). For example, the base station (e.g., using communication manager 150 and/or reception component 1102, depicted in FIG. 11) may receive a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs, as described above.

As further shown in FIG. 9, in some aspects, process 900 may include transmitting, based at least in part on receiving the msg3 report message, an update message identifying a downlink beam associated with an SSB (block 920). For example, the base station (e.g., using communication manager 150 and/or transmission component 1104, depicted in FIG. 11) may transmit, based at least in part on receiving the msg3 report message, an update message identifying a downlink beam associated with an SSB, as described above.

As further shown in FIG. 9, in some aspects, process 900 may include receiving a response message, based at least in part on transmitting the update message, indicating a confirmation of an SSB index identified in the update message or indicating a reversion to a different SSB index (block 930). For example, the base station (e.g., using communication manager 150 and/or reception component 1102, depicted in FIG. 11) may receive a response message, based at least in part on transmitting the update message, indicating a confirmation of an SSB index identified in the update message or indicating a reversion to a different SSB index, as described above.

Process 900 may include additional aspects, such as any single aspect or any combination of aspects described below and/or in connection with one or more other processes described elsewhere herein.

In a first aspect, the response message is an uplink message occurring before radio resource control setup associated with the four-step RACH procedure.

In a second aspect, alone or in combination with the first aspect, the update message is a downlink message occurring before radio resource control setup associated with the four-step RACH procedure.

In a third aspect, alone or in combination with one or more of the first and second aspects, the response message includes at least one of a first SSB index that is different from a second SSB index included in the update message, or an RSRP value for the first SSB index.

In a fourth aspect, alone or in combination with one or more of the first through third aspects, a downlink or uplink quasi-co-location parameter is based at least in part on an SSB index included in the response message.

In a fifth aspect, alone or in combination with one or more of the first through fourth aspects, the response message is constrained to include an SSB index, that is different from another SSB index of the update message, with a strongest RSRP of the plurality of RSRPs.

In a sixth aspect, alone or in combination with one or more of the first through fifth aspects, the plurality of SSB indices or the plurality of RSRPs is based at least in part on a CSI report configuration with a report quantity indicated via a system information message.

In a seventh aspect, alone or in combination with one or more of the first through sixth aspects, a request for a CSI report associated with the CSI report configuration is based at least in part on a field of a RACH resource or an uplink transmission request.

In an eighth aspect, alone or in combination with one or more of the first through seventh aspects, an indication in a msg2 of the four-step RACH procedure or another message occurs before radio resource control setup associated with triggering the CSI report.

In a ninth aspect, alone or in combination with one or more of the first through eighth aspects, the CSI report is conveyed via a physical uplink control channel or multiplexed on a physical uplink shared channel.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a beam management component 1008, among other examples.

In some aspects, the apparatus 1000 may be configured to perform one or more operations described herein in connection with FIGS. 5A and 5B. Additionally, or alternatively, the apparatus 1000 may be configured to perform one or more processes described herein, such as process 600 of FIG. 6, process 700 of FIG. 7, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit a msg1 report message, of a four-step RACH procedure, identifying information associated with a plurality of SSBs, wherein the information includes a plurality of SSB indices associated with the plurality of SSBs. The reception component 1002 may receive, based at least in part on transmitting the msg1 report message, a msg2 update message, of the four-step RACH procedure, with an indication of a downlink beam associated with an SSB index of the plurality of SSB indices. The transmission component 1004 may transmit a response message, based at least in part on receiving the msg2 update message, indicating a confirmation of the SSB index indicated in the msg2 update message or indicating a reversion to a different SSB index. The beam management component 1008 may determine a beam measurement to provide for beam prediction and may select a beam based at least in part on a received indication of a beam.

The reception component 1002 may receive a system information block including RACH configuration information, wherein the RACH configuration information identifies at least one of msg1 RACH resources for a subset of SSB indices of a set of configured SSB indices, a grouping of RACH resources, a maximum quantity of SSB indices for the msg1 report message, a maximum quantity of SSB indices for the msg2 update message, an association between first SSB indices in the msg1 report message and second SSB indices in the msg2 update message, msg1 RACH resources for the set of configured SSB indices, or a configuration of one or more combinations of SSB indices associated with the msg1 RACH resources.

The transmission component 1004 may transmit an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

The transmission component 1004 may transmit a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The reception component 1002 may receive, based at least in part on transmitting the msg3 report message, an update message identifying a downlink beam associated with an SSB. The transmission component 1004 may transmit a response message, based at least in part on receiving the update message, indicating a confirmation of an SSB index identified in the update message or indicating a reversion to a different SSB index.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a beam management component 1108, among other examples.

In some aspects, the apparatus 1100 may be configured to perform one or more operations described herein in connection with FIGS. 5A and 5B. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The reception component 1102 may receive a msg1 report message, of a four-step RACH procedure, identifying information associated with a plurality of SSBs, wherein the information includes a plurality of SSB indices associated with the plurality of SSBs. The transmission component 1104 may transmit, based at least in part on receiving the msg1 report message, a msg2 update message, of the four-step RACH procedure, with an indication of a downlink beam associated with an SSB index of the plurality of SSB indices. The reception component 1102 may receive a response message, based at least in part on transmitting the msg2 update message, indicating a confirmation of the SSB index indicated in the msg2 update message or indicating a reversion to a different SSB index.

The transmission component 1104 may transmit a system information block including RACH configuration information, wherein the RACH configuration information identifies at least one of msg1 RACH resources for a subset of SSB indices of a set of configured SSB indices, a grouping of RACH resources, a maximum quantity of SSB indices for the msg1 report message, a maximum quantity of SSB indices for the msg2 update message, an association between first SSB indices in the msg1 report message and second SSB indices in the msg2 update message, msg1 RACH resources for the set of configured SSB indices, or a configuration of one or more combinations of SSB indices associated with the msg1 RACH resources. The beam management component 1108 may predict a beam using a beam prediction procedure and may select a beam for communication.

The reception component 1102 may receive an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

The reception component 1102 may receive a msg3 report message, of a four-step RACH procedure, identifying information associated with a plurality of SSBs, wherein the information includes at least one of a plurality of SSB indices associated with the plurality of SSBs or a plurality of RSRPs corresponding to the plurality of SSB indices and the plurality of SSBs. The transmission component 1104 may transmit, based at least in part on receiving the msg3 report message, an update message identifying a downlink beam associated with an SSB. The reception component 1102 may receive a response message, based at least in part on transmitting the update message, indicating a confirmation of an SSB index identified in the update message or indicating a reversion to a different SSB index.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting a message 1 (msg1) report message, of a four-step random access channel (RACH) procedure, identifying information associated with a plurality of synchronization signal blocks (SSBs), wherein the information includes a plurality of SSB indices associated with the plurality of SSBs; receiving, based at least in part on transmitting the msg1 report message, a message 2 (msg2) update message, of the four-step RACH procedure, with an indication of a downlink beam associated with an SSB index of the plurality of SSB indices; and transmitting a response message, based at least in part on receiving the msg2 update message, indicating a confirmation of the SSB index indicated in the msg2 update message or indicating a reversion to a different SSB index.

Aspect 2: The method of Aspect 1, wherein the response message is a message 3 (msg3) of the four-step RACH procedure or another type of uplink message occurring before radio resource control setup associated with the four-step RACH procedure.

Aspect 3: The method of any of Aspects 1 to 2, wherein the msg1 report message is an enhanced msg1 including one or more fields for reporting the plurality of SSB indices.

Aspect 4: The method of any of Aspects 1 to 3, wherein the msg1 report message uses a RACH occasion or a RACH preamble partitioning to include one or more fields for reporting the plurality of SSB indices.

Aspect 5: The method of any of Aspects 1 to 4, wherein the msg1 report message includes a plurality of RACH preambles within a single RACH occasion conveying information identifying the plurality of SSB indices.

Aspect 6: The method of any of Aspects 1 to 5, wherein an order of the plurality of SSB indices within the msg1 report corresponds to an order of measured reference signal received powers (RSRPs) of the plurality of SSBs identified by the plurality of SSB indices.

Aspect 7: The method of any of Aspects 1 to 6, wherein a RACH occasion to SSB index association is based at least in part on a strongest measured reference signal received power (RSRP) of a plurality of measured RSRPs of the plurality of SSBs identified by the plurality of SSB indices.

Aspect 8: The method of any of Aspects 1 to 7, wherein the msg1 report message includes a RACH preamble associated with a RACH occasion that identifies two or more of the plurality of SSB indices.

Aspect 9: The method of any of Aspects 1 to 8, wherein the msg1 report message includes a plurality of RACH occasion sets associated with groups of SSB indices.

Aspect 10: The method of any of Aspects 1 to 9, wherein the UE is configured to determine a transmit beam based at least in part on an SSB index, of the plurality of SSB indices, with a strongest reference signal received power (RSRP).

Aspect 11: The method of any of Aspects 1 to 10, wherein the msg2 update message includes a field for an SSB index included in the plurality of SSB indices of the msg1 report message or an SSB index not included in the plurality of SSB indices of the msg1 report message.

Aspect 12: The method of Aspect 11, wherein a downlink quasi-co-location (QCL) parameter is based at least in part on at least one of a value of the SSB index of the field of the msg2 update message, or whether the SSB index is included in the plurality of SSB indices of the msg1 report message or not included in the plurality of SSB indices of the msg1 report message.

Aspect 13: The method of Aspect 12, wherein a downlink quasi-co-location parameter is based at least in part on a random access response uplink grant medium access control protocol data unit format.

Aspect 14: The method of any of Aspects 1 to 13, wherein a downlink quasi-co-location parameter is based at least in part on a grant format and a random access radio network temporary identifier associated with the msg1 report message.

Aspect 15: The method of any of Aspects 1 to 14, wherein the response message includes at least one of: a first SSB index that is different from a second SSB index included in the msg2 update message, or a reference signal received power (RSRP) value for the first SSB index.

Aspect 16: The method of any of Aspects 1 to 15, wherein the UE is configured to use a downlink or uplink quasi-co-location parameter associated with an SSB index included in the response message.

Aspect 17: The method of any of Aspects 1 to 16, wherein the response message is constrained to include an SSB index, that is different from another SSB index of the msg2 update message, with a strongest reference signal received power (RSRP).

Aspect 18: The method of any of Aspects 1 to 17, further comprising: receiving a system information block including RACH configuration information, wherein the RACH configuration information identifies at least one of: msg1 RACH resources for a subset of SSB indices of a set of configured SSB indices, a grouping of RACH resources, a maximum quantity of SSB indices for the msg1 report message, a maximum quantity of SSB indices for the msg2 update message, an association between first SSB indices in the msg1 report message and second SSB indices in the msg2 update message, msg1 RACH resources for the set of configured SSB indices, or a configuration of one or more combinations of SSB indices associated with the msg1 RACH resources.

Aspect 19: The method of any of Aspects 1 to 18, further comprising: transmitting an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

Aspect 20: A method of wireless communication performed by a user equipment (UE), comprising: transmitting a message 3 (msg3) report message, of a four-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) corresponding to the plurality of SSB indices and the plurality of SSBs; receiving, based at least in part on transmitting the msg3 report message, an update message identifying a downlink beam associated with an SSB; and transmitting a response message, based at least in part on receiving the update message, indicating a confirmation of an SSB index identified in the update message or indicating a reversion to a different SSB index.

Aspect 21: The method of Aspect 20, wherein the response message is an uplink message occurring before radio resource control setup associated with the four-step RACH procedure.

Aspect 22: The method of any of Aspects 20 to 21, wherein the update message is a downlink message occurring before radio resource control setup associated with the four-step RACH procedure.

Aspect 23: The method of any of Aspects 20 to 22, wherein the response message includes at least one of: a first SSB index that is different from a second SSB index included in the update message, or an RSRP value for the first SSB index.

Aspect 24: The method of any of Aspects 20 to 23, wherein the UE is configured to use a downlink or uplink quasi-co-location parameter associated with an SSB index included in the response message.

Aspect 25: The method of any of Aspects 20 to 24, wherein the response message is constrained to include an SSB index, that is different from another SSB index of the update message, with a strongest reference signal received power (RSRP) of the plurality of RSRPs.

Aspect 26: The method of any of Aspects 20 to 25, wherein the plurality of SSB indices or the plurality of RSRPs is based at least in part on a channel state information (CSI) report configuration with a report quantity indicated via a system information message.

Aspect 27: The method of Aspect 26, wherein the UE is configured to transmit a request for a CSI report associated with the CSI report configuration based at least in part on a field of a RACH resource or an uplink transmission request.

Aspect 28: The method of Aspect 27, wherein the UE is configured to receive an indication in a message 2 (msg2) of the four-step RACH procedure or another message before radio resource control setup associated with triggering the CSI report.

Aspect 29: The method of any of Aspects 27 to 28, wherein the UE is configured to transmit the CSI report via a physical uplink control channel or multiplexed on a physical uplink shared channel.

Aspect 30: A method of wireless communication performed by a base station, comprising: receiving a message 1 (msg1) report message, of a four-step random access channel (RACH) procedure, identifying information associated with a plurality of synchronization signal blocks (SSBs), wherein the information includes a plurality of SSB indices associated with the plurality of SSBs; transmitting, based at least in part on receiving the msg1 report message, a message 2 (msg2) update message, of the four-step RACH procedure, with an indication of a downlink beam associated with an SSB index of the plurality of SSB indices; and receiving a response message, based at least in part on transmitting the msg2 update message, indicating a confirmation of the SSB index indicated in the msg2 update message or indicating a reversion to a different SSB index.

Aspect 31: The method of Aspect 30, wherein the response message is a message 3 (msg3) of the four-step RACH procedure or another type of uplink message occurring before radio resource control setup associated with the four-step RACH procedure.

Aspect 32: The method of any of Aspects 30 to 31, wherein the msg1 report message is an enhanced msg1 including one or more fields for reporting the plurality of SSB indices.

Aspect 33: The method of any of Aspects 30 to 32, wherein the msg1 report message uses a RACH occasion or a RACH preamble partitioning to include one or more fields for reporting the plurality of SSB indices.

Aspect 34: The method of any of Aspects 30 to 33, wherein the msg1 report message includes a plurality of RACH preambles within a single RACH occasion conveying information identifying the plurality of SSB indices.

Aspect 35: The method of any of Aspects 30 to 34, wherein an order of the plurality of SSB indices within the msg1 report corresponds to an order of measured reference signal received powers (RSRPs) of the plurality of SSBs identified by the plurality of SSB indices.

Aspect 36: The method of any of Aspects 30 to 35, wherein a RACH occasion to SSB index association is based at least in part on a strongest measured reference signal received power (RSRP) of a plurality of measured RSRPs of the plurality of SSBs identified by the plurality of SSB indices.

Aspect 37: The method of any of Aspects 30 to 36, wherein the msg1 report message includes a RACH preamble associated with a RACH occasion that identifies two or more of the plurality of SSB indices.

Aspect 38: The method of any of Aspects 30 to 37, wherein the msg1 report message includes a plurality of RACH occasion sets associated with groups of SSB indices.

Aspect 39: The method of any of Aspects 30 to 38, wherein a transmit beam is based at least in part on an SSB index, of the plurality of SSB indices, with a strongest reference signal received power (RSRP).

Aspect 40: The method of any of Aspects 30 to 39, wherein the msg2 update message includes a field for an SSB index included in the plurality of SSB indices of the msg1 report message or an SSB index not included in the plurality of SSB indices of the msg1 report message.

Aspect 41: The method of Aspect 40, wherein a downlink quasi-co-location (QCL) parameter is based at least in part on at least one of a value of the SSB index of the field of the msg2 update message, or whether the SSB index is included in the plurality of SSB indices of the msg1 report message or not included in the plurality of SSB indices of the msg1 report message.

Aspect 42: The method of Aspect 41, wherein a downlink quasi-co-location parameter is based at least in part on a random access response uplink grant medium access control protocol data unit format.

Aspect 43: The method of any of Aspects 30 to 42, wherein a downlink quasi-co-location parameter is based at least in part on a grant format and a random access radio network temporary identifier associated with the msg1 report message.

Aspect 44: The method of any of Aspects 30 to 43, wherein the response message includes at least one of: a first SSB index that is different from a second SSB index included in the msg2 update message, or a reference signal received power (RSRP) value for the first SSB index.

Aspect 45: The method of any of Aspects 30 to 44, wherein a downlink or uplink quasi-co-location parameter is based at least in part on an SSB index included in the response message.

Aspect 46: The method of any of Aspects 30 to 45, wherein the response message is constrained to include an SSB index, that is different from another SSB index of the msg2 update message, with a strongest reference signal received power (RSRP).

Aspect 47: The method of any of Aspects 30 to 46, further comprising: transmitting a system information block including RACH configuration information, wherein the RACH configuration information identifies at least one of: msg1 RACH resources for a subset of SSB indices of a set of configured SSB indices, a grouping of RACH resources, a maximum quantity of SSB indices for the msg1 report message, a maximum quantity of SSB indices for the msg2 update message, an association between first SSB indices in the msg1 report message and second SSB indices in the msg2 update message, msg1 RACH resources for the set of configured SSB indices, or a configuration of one or more combinations of SSB indices associated with the msg1 RACH resources.

Aspect 48: The method of any of Aspects 30 to 47, further comprising: receiving an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

Aspect 49: A method of wireless communication performed by a base station, comprising: receiving a message 3 (msg3) report message, of a four-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) corresponding to the plurality of SSB indices and the plurality of SSBs; transmitting, based at least in part on receiving the msg3 report message, an update message identifying a downlink beam associated with an SSB; and receiving a response message, based at least in part on transmitting the update message, indicating a confirmation of an SSB index identified in the update message or indicating a reversion to a different SSB index.

Aspect 50: The method of Aspect 49, wherein the response message is an uplink message occurring before radio resource control setup associated with the four-step RACH procedure.

Aspect 51: The method of any of Aspects 49 to 50, wherein the update message is a downlink message occurring before radio resource control setup associated with the four-step RACH procedure.

Aspect 52: The method of any of Aspects 49 to 51, wherein the response message includes at least one of: a first SSB index that is different from a second SSB index included in the update message, or an RSRP value for the first SSB index.

Aspect 53: The method of any of Aspects 49 to 52, wherein a downlink or uplink quasi-co-location parameter is based at least in part on an SSB index included in the response message.

Aspect 54: The method of any of Aspects 49 to 53, wherein the response message is constrained to include an SSB index, that is different from another SSB index of the update message, with a strongest reference signal received power (RSRP) of the plurality of RSRPs.

Aspect 55: The method of any of Aspects 49 to 54, wherein the plurality of SSB indices or the plurality of RSRPs is based at least in part on a channel state information (CSI) report configuration with a report quantity indicated via a system information message.

Aspect 56: The method of Aspect 55, wherein a request for a CSI report associated with the CSI report configuration is based at least in part on a field of a RACH resource or an uplink transmission request.

Aspect 57: The method of Aspect 56, wherein an indication in a message 2 (msg2) of the four-step RACH procedure or another message occurs before radio resource control setup associated with triggering the CSI report.

Aspect 58: The method of any of Aspects 56 to 57, wherein the CSI report is conveyed via a physical uplink control channel or multiplexed on a physical uplink shared channel.

Aspect 59: An apparatus for wireless communication at a device, comprising a processor; memory coupled with the processor; and instructions stored in the memory and executable by the processor to cause the apparatus to perform the method of one or more of Aspects 1-19.

Aspect 60: A device for wireless communication, comprising a memory and one or more processors coupled to the memory, the one or more processors configured to perform the method of one or more of Aspects 1-19.

Aspect 61: An apparatus for wireless communication, comprising at least one means for performing the method of one or more of Aspects 1-19.

Aspect 62: A non-transitory computer-readable medium storing code for wireless communication, the code comprising instructions executable by a processor to perform the method of one or more of Aspects 1-19.

Aspect 63: A non-transitory computer-readable medium storing a set of instructions for wireless communication, the set of instructions comprising one or more instructions that, when executed by one or more processors of a device, cause the device to perform the method of one or more of Aspects 1-19.

Aspect 64: An apparatus for wireless communication at a device, comprising a processor; memory coupled with the processor; and instructions stored in the memory and executable by the processor to cause the apparatus to perform the method of one or more of Aspects 20-29.

Aspect 65: A device for wireless communication, comprising a memory and one or more processors coupled to the memory, the one or more processors configured to perform the method of one or more of Aspects 20-29.

Aspect 66: An apparatus for wireless communication, comprising at least one means for performing the method of one or more of Aspects 20-29.

Aspect 67: A non-transitory computer-readable medium storing code for wireless communication, the code comprising instructions executable by a processor to perform the method of one or more of Aspects 20-29.

Aspect 68: A non-transitory computer-readable medium storing a set of instructions for wireless communication, the set of instructions comprising one or more instructions that, when executed by one or more processors of a device, cause the device to perform the method of one or more of Aspects 20-29.

Aspect 69: An apparatus for wireless communication at a device, comprising a processor; memory coupled with the processor; and instructions stored in the memory and executable by the processor to cause the apparatus to perform the method of one or more of Aspects 30-48.

Aspect 70: A device for wireless communication, comprising a memory and one or more processors coupled to the memory, the one or more processors configured to perform the method of one or more of Aspects 30-48.

Aspect 71: An apparatus for wireless communication, comprising at least one means for performing the method of one or more of Aspects 30-48.

Aspect 72: A non-transitory computer-readable medium storing code for wireless communication, the code comprising instructions executable by a processor to perform the method of one or more of Aspects 30-48.

Aspect 73: A non-transitory computer-readable medium storing a set of instructions for wireless communication, the set of instructions comprising one or more instructions that, when executed by one or more processors of a device, cause the device to perform the method of one or more of Aspects 30-48.

Aspect 74: An apparatus for wireless communication at a device, comprising a processor; memory coupled with the processor; and instructions stored in the memory and executable by the processor to cause the apparatus to perform the method of one or more of Aspects 49-58.

Aspect 75: A device for wireless communication, comprising a memory and one or more processors coupled to the memory, the one or more processors configured to perform the method of one or more of Aspects 49-58.

Aspect 76: An apparatus for wireless communication, comprising at least one means for performing the method of one or more of Aspects 49-58.

Aspect 77: A non-transitory computer-readable medium storing code for wireless communication, the code comprising instructions executable by a processor to perform the method of one or more of Aspects 49-58.

Aspect 78: A non-transitory computer-readable medium storing a set of instructions for wireless communication, the set of instructions comprising one or more instructions that, when executed by one or more processors of a device, cause the device to perform the method of one or more of Aspects 49-58.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a message 1 (msg1) report message, of a four-step random access channel (RACH) procedure, identifying information associated with a plurality of synchronization signal blocks (SSBs), wherein the information includes a plurality of SSB indices associated with the plurality of SSBs;
receive, based at least in part on transmitting the msg1 report message, a message 2 (msg2) update message, of the four-step RACH procedure, with an indication of a downlink beam associated with an SSB index of the plurality of SSB indices; and
transmit a response message, based at least in part on receiving the msg2 update message, indicating a confirmation of the SSB index indicated in the msg2 update message or indicating a reversion to a different SSB index.

2. The UE of claim 1, wherein the response message is a message 3 (msg3) of the four-step RACH procedure or another type of uplink message occurring before radio resource control setup associated with the four-step RACH procedure.

3. The UE of claim 1, wherein the msg1 report message is an enhanced msg1 including one or more fields for reporting the plurality of SSB indices.

4. The UE of claim 1, wherein the msg1 report message uses a RACH occasion or a RACH preamble partitioning to include one or more fields for reporting the plurality of SSB indices.

5. The UE of claim 1, wherein the msg1 report message includes a plurality of RACH preambles within a single RACH occasion conveying information identifying the plurality of SSB indices.

6. The UE of claim 1, wherein an order of the plurality of SSB indices within the msg1 report corresponds to an order of measured reference signal received powers (RSRPs) of the plurality of SSBs identified by the plurality of SSB indices.

7. The UE of claim 1, wherein a RACH occasion to SSB index association is based at least in part on a strongest measured reference signal received power (RSRP) of a plurality of measured RSRPs of the plurality of SSBs identified by the plurality of SSB indices.

8. The UE of claim 1, wherein the msg1 report message includes a RACH preamble associated with a RACH occasion that identifies two or more of the plurality of SSB indices.

9. The UE of claim 1, wherein the msg1 report message includes a plurality of RACH occasion sets associated with groups of SSB indices.

10. The UE of claim 1, wherein the UE is configured to determine a transmit beam based at least in part on an SSB index, of the plurality of SSB indices, with a strongest reference signal received power (RSRP).

11. The UE of claim 1, wherein the msg2 update message includes a field for an SSB index included in the plurality of SSB indices of the msg1 report message or an SSB index not included in the plurality of SSB indices of the msg1 report message.

12. The UE of claim 11, wherein a downlink quasi-co-location (QCL) parameter is based at least in part on at least one of a value of the SSB index of the field of the msg2 update message, or whether the SSB index is included in the plurality of SSB indices of the msg1 report message or not included in the plurality of SSB indices of the msg1 report message.

13. The UE of claim 12, wherein a downlink quasi-co-location parameter is based at least in part on a random access response uplink grant medium access control protocol data unit format.

14. The UE of claim 1, wherein a downlink quasi-co-location parameter is based at least in part on a grant format and a random access radio network temporary identifier associated with the msg1 report message.

15. The UE of claim 1, wherein the response message includes at least one of:
a first SSB index that is different from a second SSB index included in the msg2 update message, or
a reference signal received power (RSRP) value for the first SSB index.

16. The UE of claim 1, wherein the UE is configured to use a downlink or uplink quasi-co-location parameter associated with an SSB index included in the response message.

17. The UE of claim 1, wherein the response message is constrained to include an SSB index, that is different from another SSB index of the msg2 update message, with a strongest reference signal received power (RSRP).

18. The UE of claim 1, wherein the one or more processors are further configured to:
receive a system information block including RACH configuration information, wherein the RACH configuration information identifies at least one of:
msg1 RACH resources for a subset of SSB indices of a set of configured SSB indices,
a grouping of RACH resources,
a maximum quantity of SSB indices for the msg1 report message,
a maximum quantity of SSB indices for the msg2 update message,
an association between first SSB indices in the msg1 report message and second SSB indices in the msg2 update message,
msg1 RACH resources for the set of configured SSB indices, or
a configuration of one or more combinations of SSB indices associated with the msg1 RACH resources.

19. The UE of claim 1, wherein the one or more processors are further configured to:
transmit an SSB index update message including at least one SSB index different with a value that is different from a value of the SSB index identified in the msg2 update message, wherein a downlink quasi-co-location parameter for one or more downlink messages after the msg2 update message and an uplink quasi-co-location parameter for the SSB index update message are based at least in part on the at least one SSB index.

20. A UE for wireless communication, comprising:
a memory; and
one or more processors, coupled to the memory, configured to:
transmit a message 3 (msg3) report message, of a four-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) corresponding to the plurality of SSB indices and the plurality of SSBs;
receive, based at least in part on transmitting the msg3 report message, an update message identifying a downlink beam associated with an SSB; and
transmit a response message, based at least in part on receiving the update message, indicating a confirmation of an SSB index identified in the update message or indicating a reversion to a different SSB index.

21. The UE of claim 20, wherein the response message is an uplink message occurring before radio resource control setup associated with the four-step RACH procedure.

22. The UE of claim 20, wherein the update message is a downlink message occurring before radio resource control setup associated with the four-step RACH procedure.

23. The UE of claim 20, wherein the response message includes at least one of:
a first SSB index that is different from a second SSB index included in the update message, or
an RSRP value for the first SSB index.

24. The UE of claim 20, wherein the UE is configured to use a downlink or uplink quasi-co-location parameter associated with an SSB index included in the response message.

25. The UE of claim 20, wherein the response message is constrained to include an SSB index, that is different from another SSB index of the update message, with a strongest reference signal received power (RSRP) of the plurality of RSRPs.

26. The UE of claim 20, wherein the plurality of SSB indices or the plurality of RSRPs is based at least in part on a channel state information (CSI) report configuration with a report quantity indicated via a system information message.

27. The UE of claim 26, wherein the UE is configured to transmit a request for a CSI report associated with the CSI report configuration based at least in part on a field of a RACH resource or an uplink transmission request.

28. The UE of claim 27, wherein the UE is configured to receive an indication in a message 2 (msg2) of the four-step RACH procedure or another message before radio resource control setup associated with triggering the CSI report.

29. The UE of claim 27, wherein the UE is configured to transmit the CSI report via a physical uplink control channel or multiplexed on a physical uplink shared channel.

30. A base station for wireless communication, comprising:
a memory; and
one or more processors, coupled to the memory, configured to:
receive a message 1 (msg1) report message, of a four-step random access channel (RACH) procedure, identifying information associated with a plurality of synchronization signal blocks (SSBs), wherein the information includes a plurality of SSB indices associated with the plurality of SSBs;
transmit, based at least in part on receiving the msg1 report message, a message 2 (msg2) update message, of the four-step RACH procedure, with an indication of a downlink beam associated with an SSB index of the plurality of SSB indices; and
receive a response message, based at least in part on transmitting the msg2 update message, indicating a confirmation of the SSB index indicated in the msg2 update message or indicating a reversion to a different SSB index.

31. The base station of claim 30, wherein the response message is a message 3 (msg3) of the four-step RACH procedure or another type of uplink message occurring before radio resource control setup associated with the four-step RACH procedure.

32. The base station of claim 30, wherein the msg1 report message is an enhanced msg1 including one or more fields for reporting the plurality of SSB indices.

33. A base station for wireless communication, comprising:
a memory; and
one or more processors, coupled to the memory, configured to:
receive a message 3 (msg3) report message, of a four-step random access channel (RACH) procedure, identifying information associated with a plurality of synchronization signal blocks (SSBs), wherein the information includes at least one of a plurality of SSB indices associated with the plurality of SSBs or a plurality of reference signal received powers (RSRPs) corresponding to the plurality of SSB indices and the plurality of SSBs;
transmit, based at least in part on receiving the msg3 report message, an update message identifying a downlink beam associated with an SSB; and
receive a response message, based at least in part on transmitting the update message, indicating a confirmation of an SSB index identified in the update message or indicating a reversion to a different SSB index.

34. The base station of claim 33, wherein the response message is an uplink message occurring before radio resource control setup associated with the four-step RACH procedure.

35. The base station of claim 33, wherein the update message is a downlink message occurring before radio resource control setup associated with the four-step RACH procedure.
